(19) United States
(12) Patent Application Publication
(10) Pub. No.: US 2010/0170794 A1
(43) Pub. Date: Jul. 8, 2010

(54) DIRECT CONNECT OXYGEN SENSOR

(75) Inventors: Bradley Gibson, Swartz Creek, MI (US); Teresa L. Schulke, Brighton, MI (US); Jeffrey A. Sell, West Bloomfield, MI (US); Andrew W. Baur, Waterford, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/348,960

(22) Filed: Jan. 6, 2009

(51) Int. Cl. G01N 27/26

(52) U.S. Cl. 204/406

(57) ABSTRACT

A direct connect oxygen sensor assembly is provided for measuring the proportion of oxygen in a fluid stream, and transmit signals indicative thereof to a controller. The assembly includes an oxygen sensor with a housing having an oxygen-sensing element protruding from one end thereof, and a first electrical terminal positioned at an opposing end of the sensor housing. An electrical conductor electrically couples the oxygen-sensing element to the first electrical terminal. The oxygen sensor assembly also includes a connector assembly with a housing having one or more lead wires, which are directly connected to the controller, projecting therefrom. A second electrical terminal is mounted to the connector housing, and electrically connected to the lead wires. The second electrical terminal is designed to mate with and electrically connect to the first electrical terminal. The connector housing is fabricated from a material with a working temperature of at least 200 degrees Celsius.

### TECHNICAL FIELD

The present invention relates generally to sensors for measuring the proportion of oxygen (O₂) in fluids passing throughout automobile powertrain and exhaust systems, and more specifically to connector arrangements for operatively connecting an oxygen sensor to a device capable of utilizing the signals generated by the sensor.

### BACKGROUND OF THE INVENTION

Almost all conventional motorized vehicles, such as the modern-day automobile, include an exhaust system for evacuating and mitigating the byproducts generated from normal operation of the vehicle's internal combustion engine (ICE). Most exhaust systems include a catalytic converter or similar exhaust aftertreatment device that receives output from the engine's exhaust manifold (or “header”), through a fluid conduit or “exhaust pipe”, and reduces and oxidizes the exhaust gas emissions. A muffler assembly or similar device, generally oriented downstream from the catalytic converter, attenuates noise generated by the exhaust emission process.

Electronic sensors are used in a variety of applications that require qualitative and quantitative analysis of fluids. In the automotive industry, for example, oxygen sensors, colloquially known as “O2 Sensors”, are used in internal combustion control systems to provide accurate oxygen concentration measurements of automobile exhaust gases. The oxygen concentration in the exhaust gas of an engine has a direct correlation to the air-to-fuel ratio of the fuel mixture being supplied to the engine. The measurements taken by the 02 sensor can thus be used to determine the most favorable combustion conditions, optimize the air-to-fuel ratio, maximize fuel economy, and manage exhaust emissions.

There are numerous types of oxygen sensors commercially available for automotive applications. Electrochemical type oxygen sensors typically used in automotive applications utilizes a thimble-shaped electrochemical galvanic cell which operates in the “potentiometric mode” to determine, or sense, the relative amounts of oxygen present in the engine's exhaust stream. This type of oxygen sensor includes an ionically conductive solid electrolyte material, typically titania or yttria stabilized zirconia, a porous electrode coating on the sensor's exterior, which is exposed to the exhaust stream, and a porous electrode coating on the sensor's interior, which is exposed to a known concentration of reference gas.

For oxygen, the solid electrolyte sensors are used to measure oxygen activity differences between an unknown gas sample and a known gas sample. In automotive exhaust applications, for instance, the unknown gas is exhaust and the known, reference gas is usually atmospheric air because the oxygen content in air is relatively constant and readily accessible. The gas concentration gradient across the solid electrolyte produces a galvanic potential. That is, when opposite surfaces of this galvanic cell are exposed to different oxygen partial pressures, an electromotive force (“emf”) is developed between the electrodes according to the Nernst equation:

E=AT ln(P1/P2)

where E is the cellular reduction potential or “galvanic voltage”, T is the absolute temperature of the gas, P1/P2 is the ratio of the oxygen partial pressures of the reference gas at the two electrodes, and A=R/4F, where R is the universal gas constant (R=8.314472 J·K⁻¹ mol⁻¹), and F is the Faraday constant (F=96485.3399 C/mol).

Potentiometric oxygen sensors are generally employed in the exhaust gas system of an ICE to determine qualitatively whether the engine is operating in a fuel-rich condition (the air-to-fuel ratio is “rich” with unburnt fuel) or a fuel-lean condition (the air-to-fuel ratio has an excess of oxygen), as compared to stoichiometry. After equilibration, the exhaust gases created by engines operating at these two operating conditions have two widely different oxygen partial pressures. This information is provided to an air-to-fuel ratio control system which attempts to provide an average stoichiometric air-to-fuel ratio between these two extreme conditions. At the air-to-fuel stoichiometric point, the oxygen concentration changes by several orders of magnitude. Accordingly, potentiometric oxygen sensors are able to qualitatively indicate whether the engine is operating in the fuel-rich or fuel-lean condition, without necessarily providing more specific information as to what is the actual air-to-fuel ratio.

Due to growing demands for increased fuel economy and improved emissions control, wide range oxygen sensors were developed that are capable of accurately determining the oxygen partial pressure in exhaust gas for engines operating under both fuel-rich and fuel-lean conditions. Such conditions require an oxygen sensor which is capable of rapid response to changes in oxygen partial pressure by several orders of magnitude, while also having sufficient sensitivity to accurately determine the oxygen partial pressure in both the fuel-rich and fuel-lean conditions. Oxygen sensors which produce an output proportional to the air-to-fuel ratio offer additional performance advantages for engine control systems. An oxygen sensor which operates in the diffusion limited current mode can produce such a proportional output, which provides sufficient resolution to determine the air-to-fuel ratio under fuel-rich or fuel-lean conditions. Generally, diffusion limited current oxygen sensors have a pumping cell and an oxygen storage cell for generating an internal oxygen reference. A constant emf is maintained between the storage cell and the pumping cell so that the magnitude and polarity of the pumping current can be detected as being indicative of the exhaust gas composition.

Current O2 sensor designs include two electrical connection points for electrically connecting the oxygen sensor to an electronic device, such as an onboard engine control module (ECM), which utilizes the signal produced by the sensor. One connection point is internal to the sensor, and a second, external connection point is for electrical communication with a wiring harness. In such designs, an elongated “pigtail assembly” electrically links these two electrical connection points. The pigtail assembly has a distinct electrical connector at each opposing end thereof: a first metal connector clip for connecting to the connection point internal to the sensor, and a second, less-expensive plastic connector clip for attaching the pigtail assembly to a vehicle wiring harness.

The two connection points are separated through utilization of the pigtail assembly in order to isolate the external connection point, and package it away from the extreme heat conditions where the O2 sensor is normally packaged. The oxygen sensor is located in an environment that is very hot during normal sensor use, and also very cold under certain operating conditions. The sensor may reach temperatures upwards of 850° C. at the point at which it projects into the exhaust pipe. Moreover, the electrical connection at the oxygen sensor is subject to adverse road conditions that may include salt spray, humidity, water, oil, grease and the exhaust gases themselves. The pigtail plastic connector clip is not designed to withstand this harsh working environment.

### SUMMARY OF THE INVENTION

According to one embodiment of the present invention, a direct connect oxygen sensor assembly is provided for measuring the proportion of oxygen in a passing fluid stream, and transmitting signals indicative thereof to a controller. The oxygen sensor assembly includes an oxygen sensor that is configured to operatively connect to a fluid conduit, such as the engine's exhaust manifold or an exhaust pipe downstream therefrom. The oxygen sensor has a sensor housing with an oxygen-sensing element that protrudes, at least partially, from one end of the sensor housing, and a first electrical terminal positioned at an opposing end of the sensor housing. An electrical conductor electrically couples the oxygen-sensing element with the first electrical terminal.

The oxygen sensor assembly also includes a connector assembly that has a connector housing with one or more lead wires projecting therefrom. The lead wires are operatively connected to the controller. A second electrical terminal is mounted to the connector housing, and electrically coupled to the lead wire(s). The second electrical terminal is configured to mate with and electrically connect to the first electrical terminal. The connector housing is fabricated from a material with a working temperature of at least 200 degrees Celsius (° C.), such as, for example, stainless steel. The connector housing is ideally fabricated from the same material as the sensor housing, but may be fabricated from other thermally resilient materials.

The present invention offers numerous advantages over prior art oxygen sensor and electrical connector arrangements. This design allows for a direct connect oxygen sensor concept that is functional from a thermal, vibration, and packaging standpoint. The oxygen sensor assembly described above is significantly smaller than prior art assemblies, requiring substantially less packaging space. In addition, this design eliminates the need for current-production pigtail assemblies with an external connector. In fact, this design eliminates the need for any additional electrical connection points between the oxygen sensor and the controller. Eliminating this unneeded extra component reduces engineering, packaging, shipping, and installation costs, minimizes warranty issues, and simplifies the design, validation, and release process.

According to one aspect of this particular embodiment, the oxygen sensor's electrical terminal includes either a plurality of electrical prongs or a plurality of complementary female connectors. In this instance, the connector assembly's electrical terminal includes the other of the plurality of electrical prongs and female connectors. Each female connector is designed to receive and electrically connect to a respective one of the plurality of electrical prongs.

In accordance with another aspect of this embodiment, the sensor housing includes a generally cylindrical body portion with a generally cylindrical protection tube that protrudes axially from one end thereof. The oxygen-sensing element is encased within the protection tube and the body portion. Ideally, the protection tube defines at least one aperture such that the unknown fluid sample (e.g., exhaust gas) can operatively interface with the oxygen-sensing element.

As part of another aspect, the connector housing includes a connector shell with a terminal shield that protrudes from one side thereof. The terminal shield circumscribes the connector assembly terminal. In this particular instance, when the connector assembly is attached to the oxygen sensor, the terminal shield is disposed inside of the oxygen sensor's electrical terminal, while the connector shell is disposed along an exterior surface of the oxygen sensor's electrical terminal.

As part of yet another facet of this embodiment, the first electrical terminal preferably includes one or more teeth that project from an interior surface thereof. The connector housing terminal shield defines a corresponding number of key slots each configured to receive one of the teeth. The tooth-and-key slot feature ensures that the first and second terminals are properly aligned when connecting the oxygen sensor to the connector assembly.

In accordance with yet another aspect, the oxygen sensor assembly includes a twist-lock feature. The first electrical terminal includes one or more tabs that project outward from an exterior surface thereof. The connector housing, on the other hand, defines a corresponding number of channels each configured to receive a tab therein. By inserting the tabs into their respective channels, pressing the connector housing together with the sensor housing, and thereafter twisting the two housings in opposite directions, the connector assembly will lock to the oxygen sensor.

According to another feature of this embodiment, a connector position assurance (CPA) pin may be included. The CPA pin is configured mate with the oxygen sensor and connector assembly, and ensure a proper electrical connection between the first and second electrical terminals. For instance, the CPA pin may have a u-shaped design, with a base having legs projecting from opposing ends thereof. The connector shell may define two receiving passages each configured to receive and mate with a respective leg only when the sensor and connector housings are properly attached.

Another feature of this embodiment is to include a thermally resilient seal member, such as a Teflon seal ring, between the first and second electrical terminals.

In accordance with another embodiment of the present invention, an oxygen sensor assembly is provided for sensing the proportion of oxygen in gaseous exhaust expelled from an internal combustion engine, and transmitting signals indicative thereof to an engine control module. The oxygen sensor assembly comprises an oxygen sensor and a connector assembly. The oxygen sensor is configured to mount, at least partially, inside one of the vehicle's exhaust pipes. The oxygen sensor has a metallic housing with an oxygen-sensing element that is disposed within, and protrudes at least partially from one end thereof. The oxygen sensor also includes an electrical terminal with a plurality of electrical prongs that protrude from an opposing end of the sensor housing. An electrical conductor, which is disposed inside the sensor housing, electrically couples the oxygen-sensing element to the plurality of electrical prongs.

The connector assembly has a metallic connector housing that is configured to mate with and attach to the oxygen sensor housing. The connector housing includes a plurality of insulated lead wires that are connected directly to the engine control module, and extend outward from one side thereof. The connector assembly also has an electrical terminal with a plurality of female connectors that project from an opposing side of the connector housing. Each of the female connectors is electrically connected to a respective one of the lead wires, and is configured to receive a respective one of the electrical prongs protruding from the oxygen sensor terminal. The connector housing is fabricated from a metallic material that will not significantly melt or warp at 200° C.

The above features and advantages, and other features and advantages of the present invention, will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a partially-schematic, exploded side-view illustration of an oxygen sensor assembly in accordance with the present invention;

FIG. 2 is a schematic partial cross-sectional, side-view illustration of an exemplary oxygen sensor; and

FIG. 3 is an exploded perspective-view illustration of the oxygen sensor assembly of FIG. 1.

### DESCRIPTION OF THE PREFERRED EMBODIMENTS

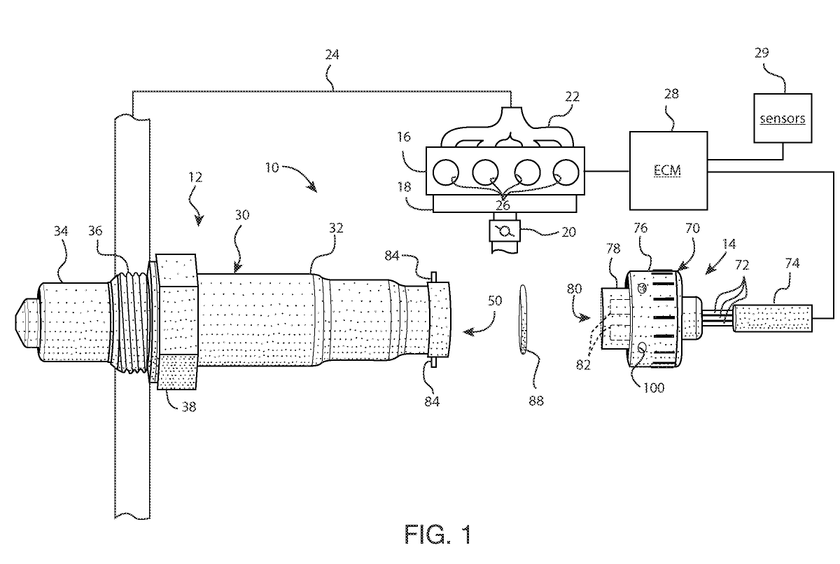

Referring to the drawings, wherein like reference numbers refer to like components throughout the several views, there is shown in FIG. 1 an oxygen sensor assembly, indicated generally as 10, in accordance with the present invention. FIG. 1 also presents an exemplary application by which the present invention may be practiced. The present invention, however, is by no means limited to the application or arrangement shown in FIG. 1. Also, although the oxygen sensor assembly 10 is intended for use in a conventional automobile, such as, but not limited to, standard passenger cars, sport utility vehicles (SUV), light trucks, minivans, and the like, it may be incorporated into any motorized vehicle application, including, but certainly not limited to, buses, heavy duty vehicles, tractors, boats and personal watercraft, airplanes, etc. In addition, the drawings presented herein are not to scale, and are provided purely for instructional purposes. As such, the specific and relative dimensions and orientations shown in the drawings are not to be considered limiting. Finally, the use of such terminology as “sensing”, “detecting”, “measuring”, “calculating”, and “determining” is not intended as limiting, and should be considered relatively interchangeable.

The oxygen sensor assembly 10 of the present invention consists of two primary components: an oxygen sensor 12 and a connector assembly 14. As will be readily understood from the following detailed description, however, additional components may be included in the oxygen sensor assembly 10, or modifications made thereto, within the scope of the appended claims. The oxygen sensor 12 is a device which detects, measures, or otherwise senses the amount or proportion of oxygen in a fluid, such as the exhaust gases produced by an internal combustion engine (ICE) assembly 16 or the like.

FIG. 1 presents a representative application by which the oxygen sensor assembly 10 of the present invention may be incorporated and utilized. The ICE assembly 16 includes an air intake system, which is represented herein by an intake manifold 18 which is in downstream fluid communication with a throttle body 20 (also known as “throttle valve”). Air is drawn into the ICE 16 through the intake manifold 18. The throttle body 20 operates to regulate the volume of air drawn into the engine 16. The intake manifold 18 is responsible for evenly distributing the fuel air mixture to the intake ports (not shown) of the various variable volume combustion chambers 26 of the ICE 16.

The ICE 16 also includes an exhaust system that operates to receive and expel exhaust gases from the combustion chambers 26. The exhaust system is represented herein by an exhaust manifold 22 (also referred to in the art as “exhaust header”), which fluidly couples the engine 16 to an exhaust pipe 24. The exhaust manifold 22 collects the exhaust expelled from the various combustion chambers 26 during operation of the ICE 16, and the pipe 24 transmits the gases away from the ICE 16. Notably, the ICE, air intake system, and exhaust system shown in FIG. 1 hereof have been greatly simplified, it being understood that further information regarding the function and operation of such systems may be found in the prior art.

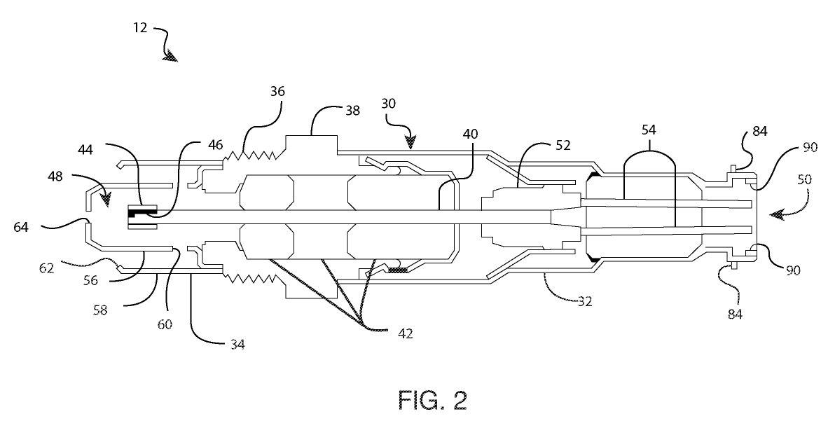

The oxygen sensor 12 is operatively connected to the exhaust pipe 24 to provide an output signal, which is preferably proportional to the oxygen partial pressure in the exhaust gas mixture of the ICE 16, to an electronic control unit (or “controller”), such as engine control module (ECM) 28. In the embodiment of FIG. 2, the oxygen sensor 12 includes a sensor housing 30 comprising an elongated, generally cylindrical, hollow metal sensor body 32 coaxially adjacent to a generally cylindrical, tubular metal protection tube 34. The protection tube 34 is press fit, fastened, or adhered to one end of the sensor body 32. The sensor body 32, which is preferably fabricated from stainless steel or other thermally resilient material, includes a threaded outer surface 36 that is used to threadably mate and secure the oxygen sensor 12 to the vehicle exhaust system, namely exhaust pipe 24, such that the tip of the protection tube 34 is exposed to the flowing exhaust stream. A hex portion 38 is provided to transfer torque, for example from a torque wrench, to the body of the sensor housing 30 in order to tightly screw the sensor 12 into its complementary receiving boss in the exhaust pipe 24. Recognizably, other means of fastening the oxygen sensor 12 to the exhaust pipe 24 are available.

With particular reference to FIG. 2, the oxygen sensor 12 is shown in an exemplary configuration. The oxygen sensor 12 includes an oxygen-sensing element 40, which is supported inside the housing 30, for example, by one or more support tubes 42. The oxygen-sensing element 40 may be of any known type. By way of example, and certainly not limitation, the oxygen-sensing element 40 may be of the narrow band type or the wide band type. Narrow band oxygen sensors, such as a conical zirconia sensor, generate a non-linear (i.e., binary) output voltage based on the quantity of oxygen in the exhaust. The output voltage generated by a narrow band oxygen sensor may be used to determine whether the engine 16 is operating in a “lean” or a “rich” state, as described hereinabove. Wide band oxygen sensors, such as a planar zirconia sensor, generate a generally linear output voltage based on the quantity of oxygen in the exhaust. Thus, wide band oxygen sensors may be used to determine the specific oxygen content in the exhaust, and whether the engine is operating in a fuel-lean or a fuel-rich state.

The oxygen-sensing element 40 is shown as a generally flat, elongated piece, extending axially within the sensor housing 30. A sensing member 44 is disposed on one end of the oxygen-sensing element 40, enclosed within a sensing chamber 48 defined by the protection tube 34. In the exemplary embodiment of FIG. 2, the sensing member 44 includes an optional, integrally-formed heating element 46. The heating element 46 is included to provide supplemental heat to warm the sensing member 44 to within a temperature range above its sensitivity temperature. For example, the heating element 46 may be used to warm the sensing member 44 to a temperature above 350 degrees Celsius (° C.). Other arrangements for the oxygen-sensing element 40 are envisioned within the scope of the present invention.

A first electrical terminal, indicated generally by reference numeral 50 in FIG. 2, protrudes from the sensor body 32, at an opposite end from the protection tube 34. An electrical conductor 52 is disposed within the sensor body portion 32 of the sensor housing 30. The electrical conductor 52 acts to electrically couple the oxygen-sensing element 40, sensing member 44, and heating element 46 with a plurality of electrical prongs 54. The prongs 54, which extend longitudinally within the sensor housing 30, are fixed at one end to the electrical conductor 52, and exposed at an opposing end which extends through the first electrical terminal 50 to an open end thereof. Only two electrical prongs 54 are illustrated in the various views of the drawings; however, the electrical terminal 50 may include fewer or greater than two prongs, depending on the particular configuration of the sensing member 44 and the heating element 46, and the specific design requirements for the intended application of the oxygen sensor 12. The prongs 54 may also be plated with gold or silver to improve the electrical conductive characteristics thereof.

A voltage forms at the sensing member 44 based upon the concentration of oxygen in the exhaust gas passing through the exhaust pipe 24. This voltage is output from the oxygen sensor 12 via terminal 50. The engine control module (ECM) 28 receives the output signal of the oxygen sensor 12 in conjunction with signals from other sensors, collectively represented in FIG. 1 at 29. The other sensors 29 may include, for example, a mass air flow (MAF) sensor, a manifold absolute pressure (MAP) sensor, an engine coolant temperature (ECT) sensor, a throttle position sensor (TPS), etc. The ECM 28 regulates the air-fuel mixture distributed to the engine 16 based, at least partially, upon the output of the oxygen sensor 12 and the other sensors 29.

In the exemplary implementation shown in FIG. 1, the ECM 28 regulates the air-fuel mixture by manipulating the position of a throttle valve within the throttle body 20 to increase or decrease the volume of air drawn into the engine 16 through intake manifold 18. The ECM 28 also regulates the air-to-fuel mixture by instructing a fuel injection system (not shown) to increase or decrease the fuel content of the air-fuel mixture. By measuring the proportion of oxygen in the remaining exhaust gas, and by knowing the volume and temperature of the air entering the cylinders, among other things, the ECM 28 can determine the amount of fuel required to burn at the stoichiometric ratio (14.7:1 air:fuel by mass for gasoline), for example using specialized look-up tables, to ensure complete combustion.

The operative connection between the sensor 12 and fluid conduit (e.g., exhaust pipe 24), whether it be direct (as shown in FIG. 1) or otherwise, places the oxygen-sensing element 40 in fluid communication with the exhaust gas. The protection tube 34, which is preferably fabricated from stainless steel or other thermally resilient material, is designed to shield the sensing element 40 from direct impingement by the exhaust gases, and protect the sensing member 44 from water or other liquids entrained in the exhaust stream. In the exemplary configuration shown in FIG. 2, for instance, the protection tube 34 includes a tubular inner shield 56 that is circumscribed by a concentrically oriented, tubular outer shield 58. The inner and outer shields 56, 58 individually and cooperatively define three openings, such as first, second and third openings 60, 62 and 64, respectively, through which exhaust gas may enter cavity 48.

The openings 60, 62, 64 may be of varying sizes and shapes. The openings 60, 62, 64 may be located and sized to produce a particular response of the oxygen-sensing element 40 to changes in the oxygen content of the exhaust gas. Additionally, the openings 60, 62, 64 may be located and sized to affect a thermal response of the oxygen-sensing element 40 to liquid water impingement. Put another way, the amount of and location where liquid water may contact the oxygen-sensing element 40 may depend on the location and size of the openings 60, 62, 64, which thereby affects the thermal response of the oxygen-sensing element 40.

Turning back now to FIG. 1, the connector assembly 14, which is intended as a direct extension of the vehicle's standard production wiring harness, acts to operatively connect (i.e., electrically couple) the oxygen sensor 12 directly to the ECM 28. The connector assembly 14 consists generally of a connector housing 70 with an array of thermally insulated lead wires 72 that project from a rear side thereof. The lead wires 72 are sheathed within and insulated by boot 74, which may be a thermally and electrically insulating silicone elastic polymer, fiber-reinforced polymer, or other suitable material. Unlike most conventional electrical connector arrangements, the lead wires 72 are connected directly to the engine control module 28, as will be explained in more detail hereinbelow. The number and gauge of the lead wires 72 may be tailored to meet the specific needs of the intended application of the oxygen sensor assembly 10.

The connector housing 70 includes a generally cylindrical, cap-like connector shell 76 with a concentrically oriented, generally cylindrical terminal shield 78 that protrudes from a front side thereof, in opposing spaced relation to the lead wires 72. The connector housing 70 is fabricated from a material with a working temperature of at least 200 degrees Celsius (° C.). That is, the connector housing 70 is constructed from a material that will not significantly deform, melt, or warp and, thus, retain full functionality at temperatures up to 200° C., and preferably up to 230° C. or higher. The connector housing 70 is ideally fabricated from the same material as the sensor housing 30, such as, for example, stainless steel, but may be fabricated from other thermally resilient materials. For example, the terminal shield 78 may be fabricated from ceramic, a fluoropolymer, such as polytetrafluoroethylene, other ferrous metals, etc.

The terminal shield 78 circumscribes a second electrical terminal, designated generally by 80 in FIG. 1, which generally comprises of a plurality of female connectors (two of which are shown hidden in FIG. 1 at 82) that project orthogonally from the front side of the connector housing 70. Each of the female connectors 82 is electrically connected to a respective one of the lead wires 72 (e.g., via crimping, soldering, clips, etc.), and is configured to receive a respective one of the electrical prongs 54 protruding from the oxygen sensor terminal 50. In the exemplary configuration presented in FIG. 1, the female connectors 82 include a metal body that defines a cavity with a profile that matches that of the interface portion of a prong 54. When the connector assembly 14 is attached to the oxygen sensor 12, as explained hereinbelow, the female connectors 82 are positioned so as to slidably receive the prongs 54. At this time, the terminal shield 78 is disposed inside of the oxygen sensor's electrical terminal 50, generally circumscribing electrical prongs 54, while the connector shell 76 surrounds the oxygen sensor's electrical terminal 50, disposed generally around an exterior surface thereof. Similar to the prongs 54, the female connectors 82 may be plated with gold or silver to improve the electrical conductive characteristics thereof.

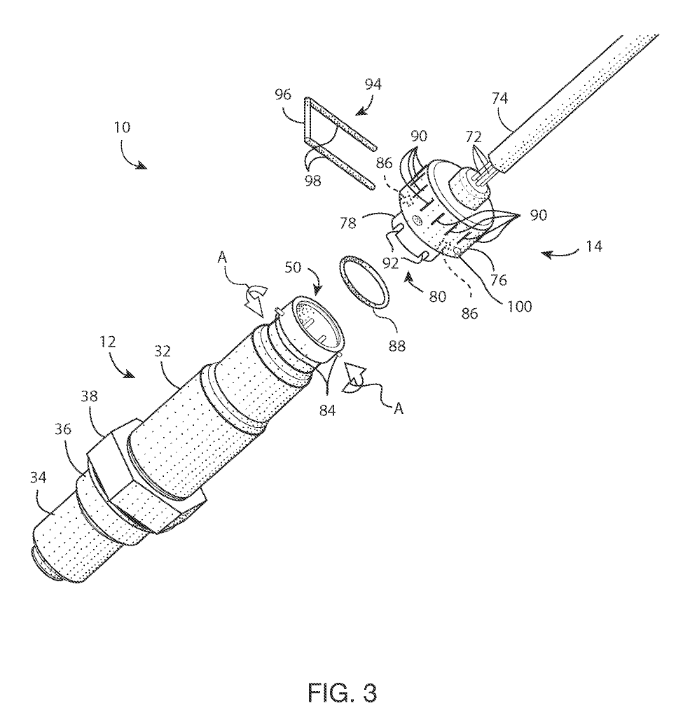

The connector housing 70 is configured to mate with and attach to the oxygen sensor housing 30. In one particular embodiment, the oxygen sensor assembly 10 includes a “twist-lock feature”. The sensor body 32 includes one or more tabs 84 that are circumferentially spaced around, and project radially outward from an exterior surface of the first electrical terminal 50. The connector housing 70, on the other hand, defines a corresponding number of female channels or grooves (two of which are shown hidden in FIG. 3 at 86) that are each configured to receive a tab 84 therein. By inserting the tabs 84 into their respective channels 86, pressing, pushing, or otherwise translating the sensor and connector housings 30, 70 together, and thereafter twisting one or both of the housings (represented in FIG. 3 by arrows A), the connector assembly 14 will lock to the oxygen sensor 12.

A thermally resilient seal member, such as polytetrafluoroethylene seal ring 88, is placed between the first and second electrical terminals 50, 80. The seal ring 88 has a working temperature of 260° C., and provides a weather-proof, water-tight, thermally resilient seal between the oxygen sensor 12 and connector assembly 14. In an alternative embodiment, the tabs 84 may be replaced with a threaded outer surface that threadably mates with a threaded inner surface of the connector shell 76 which, when engaged, mechanically secure the oxygen sensor housing 30 to the connector housing 70. In another example, the twist-lock feature presented herein can be replaced with a “quick connect” interface. An array of flexible finger grips 90 are circumferentially spaced about the outer periphery of the connector shell 76, creating a more “gripable”, user-friendly surface for screwing the oxygen sensor housing 30 together with the connector housing 70.

The oxygen sensor assembly 10 may also be fabricated with a tooth-and-key feature designed to ensure that the first and second terminals 50, 80 are properly aligned when connecting the oxygen sensor 12 to the connector assembly 14. The sensor body 32 preferably includes one or more teeth (two of which are shown in FIG. 2 at 90) that are circumferentially spaced around, and project radially inward from an interior surface of the first electrical terminal 50. As seen in FIG. 3, the connector housing terminal shield 78 defines a corresponding number of elongated key slots 92, each of which is sized and positioned to receive one of the teeth 90 when the first and second terminals 50, 80, namely the electrical prongs 54 and female connectors 82, are properly oriented.

A connector position assurance (CPA) pin 94 may also be included. The CPA pin 94 is configured to mate with the oxygen sensor 12 and connector assembly 14, and ensure a proper electrical connection between the first and second electrical terminals 50, 80. For instance, the CPA pin may have a u-shaped design, with a base 96 having legs 98 projecting from opposing ends thereof. In the embodiment shown in FIG. 3, for example, the connector shell 76 defines two receiving passages 100 (one of which is seen in FIG. 1 and one in FIG. 3). Each passage 100 is configured to receive and mate with a respective leg 98 only when the sensor and connector housings 30, 70 are properly attached. In general, the CPA pin 94 cannot be engaged unless and until the connector assembly 14 has been fully twisted down into its seated position. The CPA pin 94 gives an operator assurance that they made a proper connection, and allows for others (such as a quality point inspector) to conduct a visual check to assure a fully seated connector.

The direct connect design presented herein would allow for one part per technology, eliminating prior art pigtail assemblies and all intermittent connection points between the oxygen sensor assembly 10 and the ECM 28. This would greatly increase the economy of scale—make many more of each part number. The present invention would also allow the sensor 12 to be installed, serviced, packaged, and treated in its simplest form. Unlike the present invention, the integral pigtail design means that service must replace the sensor plus the pigtail instead of just the sensor. This would reduce warranty and greatly simplify the design and release process. It would allow for tremendous reduction in overall number of parts and increase response time for service.

While the best modes for carrying out the present invention have been described in detail, those familiar with the art to which this invention relates will recognize various alternative designs and embodiments for practicing the invention within the scope of the appended claims.

1. An oxygen sensor assembly for measuring the proportion of oxygen in a passing fluid stream and transmitting signals indicative thereof to a controller, the oxygen sensor assembly comprising:
an oxygen sensor configured to operatively connect to a fluid conduit, the oxygen sensor having a sensor housing with an oxygen-sensing element protruding at least partially from one end thereof, a first electrical terminal operatively positioned at an opposing end of the sensor housing, and at least one electrical conductor electrically coupling the oxygen-sensing element with the first electrical terminal; and
a connector assembly having a connector housing with at least one lead wire projecting therefrom to operatively connect with the controller, and a second electrical terminal operatively mounted to the connector housing and electrically connected to the at least one lead wire, the second electrical terminal being configured to mate with and electrically connect to the first electrical terminal;
wherein the connector housing is fabricated from a material with a working temperature of at least 200 degrees Celsius.

2. The oxygen sensor assembly of claim 1, wherein the sensor housing and connector housing are at least partially composed of stainless steel.

3. The oxygen sensor assembly of claim 1, characterized by the absence of a pigtail assembly electrically connecting the oxygen sensor to the controller.

4. The oxygen sensor assembly of claim 1, wherein the connector assembly is characterized by the absence of an additional electrical connection point between the second electrical terminal and the controller.

5. The oxygen sensor assembly of claim 1, wherein the first electrical terminal includes one of a plurality of electrical prongs and a plurality of female connectors, and wherein the second electrical terminal includes the other of the plurality of electrical prongs and female connectors, each of the plurality of female connectors configured to receive a respective one of the plurality of electrical prongs.

6. The oxygen sensor assembly of claim 1, wherein the sensor housing includes a generally cylindrical body portion with a generally cylindrical protection tube protruding axially from one end thereof, the oxygen-sensing element being encased within the protection tube and the body portion.

7. The oxygen sensor assembly of claim 1, wherein the connector housing includes a connector shell with a terminal shield protruding from one side thereof, wherein the terminal shield is disposed within the first electrical terminal and the connector shell is disposed along an exterior surface of the first electrical terminal when the connector assembly is attached to the oxygen sensor.

8. The oxygen sensor assembly of claim 7, wherein the first electrical terminal includes at least one tooth projecting from an interior surface thereof, and wherein the connector housing terminal shield defines at least one key slot configured to receive the at least one tooth and thereby ensure the first and second terminals are properly aligned when connecting the oxygen sensor to the connector assembly.

9. The oxygen sensor assembly of claim 1, wherein the first electrical terminal includes at least one tab projecting from an exterior surface thereof, and wherein the connector housing defines at least one channel configured to receive the at least one tab therein and thereby lock the connector assembly to the oxygen sensor.

10. The oxygen sensor assembly of claim 1, further comprising:
a connector position assurance pin configured to mate with one of the oxygen sensor and connector assembly and thereby ensure a proper electrical connection between the first and second electrical terminals.

11. The oxygen sensor assembly of claim 1, further comprising:
a seal member disposed between the first and second electrical terminals.

12. An oxygen sensor assembly for sensing the proportion of oxygen in gaseous exhaust expelled from an internal combustion engine, and transmitting signals indicative thereof to an engine control module, the oxygen sensor assembly comprising:
an oxygen sensor configured to mount at least partially inside a vehicle exhaust pipe, the oxygen sensor having a metallic sensor housing with an oxygen-sensing element disposed within and protruding at least partially from one end thereof, a first electrical terminal having a plurality of electrical prongs protruding from an opposing end of the sensor housing, and at least one electrical conductor disposed inside the sensor housing and electrically coupling the oxygen-sensing element with the plurality of electrical prongs; and
a connector assembly having a metallic connector housing with a plurality of insulated lead wires connected directly to the engine control module extending from one side of said connector housing, and a second electrical terminal with a plurality of female connectors projecting from an opposing side of said connector housing, wherein each of the plurality of female connectors is electrically connected to a respective one of the plurality of lead wires and configured to receive a respective one of the plurality of prongs, the connector housing configured to mate with and attach to the oxygen sensor housing;
wherein the connector housing is fabricated from a metallic material that will not substantially melt or warp at 200 degrees Celsius.

13. The oxygen sensor assembly of claim 12, wherein the sensor housing includes a generally cylindrical body portion with a generally cylindrical protection tube protruding axially from one end thereof, the oxygen-sensing element being encased within the protection tube and the body portion, the protection tube defining at least one aperture such that exhaust gas can operatively interface with the oxygen-sensing element.

14. The oxygen sensor assembly of claim 13, wherein the connector housing includes a generally cylindrical connector shell with a tubular terminal shield protruding from one side thereof and circumscribing the plurality of female connectors, wherein the terminal shield is disposed within the first electrical terminal circumscribing the plurality of electrical prongs, and the connector shell circumscribes an exterior surface of the first electrical terminal when the connector assembly is attached to the oxygen sensor.

15. The oxygen sensor assembly of claim 14, wherein the first electrical terminal includes an array of tabs projecting from the exterior surface thereof, and wherein the connector housing defines an array of channels each configured to receive a respective tab, wherein inserting the array of tabs into the array of channels and rotating the connector housing with respect to the sensor housing will thereby lock the oxygen sensor to the connector assembly.

16. The oxygen sensor assembly of claim 15, wherein the first electrical terminal includes a plurality of teeth projecting from an interior surface thereof, and wherein the connector housing terminal shield defines a plurality of key slots each configured to receive a respective tooth and thereby ensure the first and second terminals are properly aligned when connecting the oxygen sensor to the connector assembly.

17. The oxygen sensor assembly of claim 17, further comprising:
a u-shaped connector position assurance pin having a base with legs projecting from opposing ends thereof, wherein the connector shell defines two receiving passages each configured to receive and mate with a respective leg and thereby ensure a proper electrical connection between the first and second electrical terminals when the oxygen sensor is attached to the connector assembly.

18. The oxygen sensor assembly of claim 17, further comprising:
a Teflon seal ring disposed between the first and second electrical terminals.
